(19) United States
(12) Patent Application Publication
(10) Pub. No.: US 2011/0242008 A1
(43) Pub. Date: Oct. 6, 2011

(54) SYSTEM, METHOD AND APPARATUS FOR INITIATING A USER INTERFACE

(75) Inventor: Timothy Almeida, Corona, CA (US)

(73) Assignee: VIZIO Inc., Irvine, CA (US)

(21) Appl. No.: 12/753,297

(22) Filed: Apr. 2, 2010

(51) Int. Cl. G06F 3/041

(52) U.S. Cl. 345/173

(57) ABSTRACT

An application for a device or television has a detector capable of determining the location of a viewer in a range of the device or television. In response to the viewer coming within a pre-determined distance of the device/television, a touch-screen user interface is presented for the viewer to interact using a touch-screen interface integrated into a display of the device.

### FIELD

This invention relates to the field of display devices and more particularly to a system for detecting the proximity of a user and initiating a touch-screen user interface when the viewer nears the display device.

### BACKGROUND

Display devices such as computers, LCD or Plasma televisions often include a touch screen interface for adjusting parameters such as inputs, volume, channel, etc.

A touch-screen is an electronic system integrated with a visual display that can detect the presence and location of a touch within the display area. The term touch-screen generally refers to touch or contact to the display of the device by a finger. Many touch-screens also sense other objects, such as a plastic pen. The touch-screen allows a viewer to interact physically with what is shown on a display (a form of “direct manipulation”) such as typing on a displayed keyboard by touching the letters.

A touch-screen enables a viewer to interact directly with what is displayed on the screen rather than indirectly with a mouse or touchpad. There is usually no intermediate device, unless a pen or a stylus is required by the touch-screen or preferred by the viewer. A touch screen integrated into a device such as a television or computer system is often dormant, for example when the viewer is sitting away from the television or when a computer user is typing on a keyboard of the computer system. In such, when the viewer wishes to use the touch features, for example of the television, the viewer needs to initiate a user interface (e.g. through a remote control), then approach the television to interact directly with the touch-screen.

What is needed is device that detects the proximity of a viewer and, when the viewer is close to the device, automatically initiates a touch-screen user interface.

### SUMMARY

The present invention includes a device with a detector capable of determining the proximity of at least one viewer. In response to viewers nearing the device, the device presents a touch-screen user interface for the viewer(s) to interact with the device through touches on a display of the device. When the sensor determines the viewer(s) are no longer near, the touch-screen user interface is optionally removed from the display.

In one embodiment, a system for controlling a touch-screen of a device is disclosed. The device has a display, a processing element operatively coupled to the display, a touch-screen coupled to the display and operatively coupled to the processor, and a sensing device operatively coupled to the processing element. Software running on the processing element measures a proximity of a viewer to the display and, if the proximity is within a pre-determined distance, the software enables the touch-screen and displays a touch-screen user interface on the display.

In another embodiment, a system for controlling a touch-screen of a device is disclosed. The device includes a display, a processing element operatively coupled to the display and a sensing device operatively coupled to the processing element. Software running on the processing element reads the sensing device and determines if a viewer is within a pre-determined distance of the display and, if the viewer is within the pre-determined distance of the display, the software displays a touch-screen user interface on the display.

In another embodiment, a method of controlling a user interface of a device is disclosed including providing a sensor that determines a distance between the device and a viewer then detecting when the distance is less than a pre-determined distance and if the distance is less than the pre-determined distance, displaying a touch-screen user interface on a display of the device.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view of a device (television) having a touch-screen and proximity sensor.

FIG. 2 illustrates a schematic diagram of a typical television having a touch-screen and proximity sensor.

FIG. 3 illustrates a flow chart of a program implementing a touch-screen user interface.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures. The touch-screen is any touch-screen integrated into, on or around a display of a device. There are many touch-screen technologies, including capacitive, resistive, ultrasonic triangulation, light-beam interruption, mechanical locating, etc, all of which are anticipated. Throughout this description, a television is used as a typical device having a display and user interface. This is but an example of such devices, the list of which include, but is not limited to, picture frames, internet radios, computers, media players, cellular phones, appliances, etc.

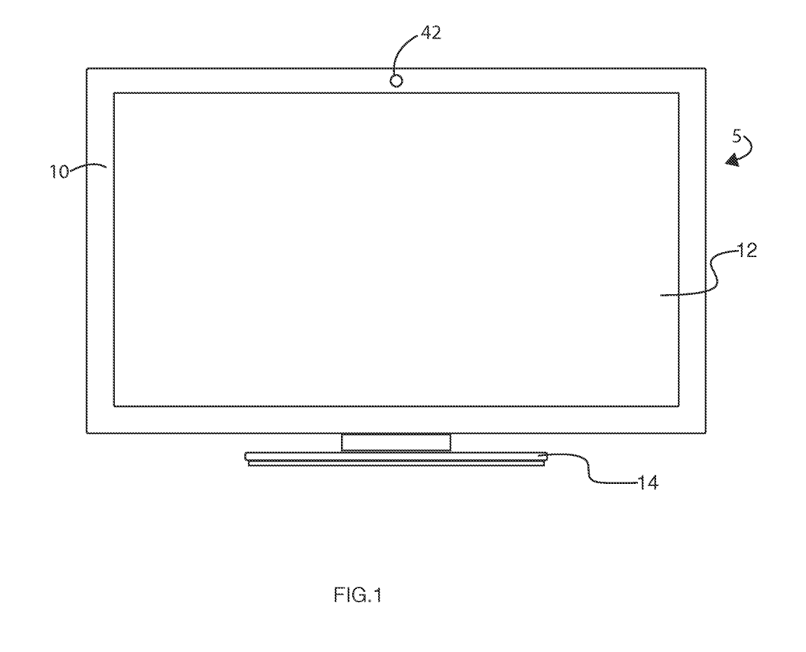

Referring to FIG. 1, a plan view of a television 5 is described. Typically, a bezel 10 is situated around the peripheral edge of the display panel 12. For completeness, though not required in the present invention, the television is shown on a stand 14.

In this example, a sensor 42 is integrated into the bezel 10. Although shown integrated into the bezel 10, it is anticipated that the sensor 42 be at any location in which the sensor 42 is able to determine when a person (viewer) or object is in the proximity of the display 12 (e.g., within a pre-determined distance of the display 12). It is anticipated that the proximity is pre-determined based upon the device (television 5 in this example) and that in some embodiments, the proximity is adjustable by the viewer. For example, one typical proximity distance for a television 5 is three feet. When the viewer approaches the television 5, the sensor 42 determines when the viewer is within the pre-determined distance (e.g. within three feet) of the display 12. When the device is, for example, a personal computer with a touch-screen monitor, a typical pre-determined distance is six inches since the user often sits closer than three feet from the monitor. In this, when the user or hand of the user gets within, for example, six inches of the monitor, the sensor 42 detects that the user is in proximity.

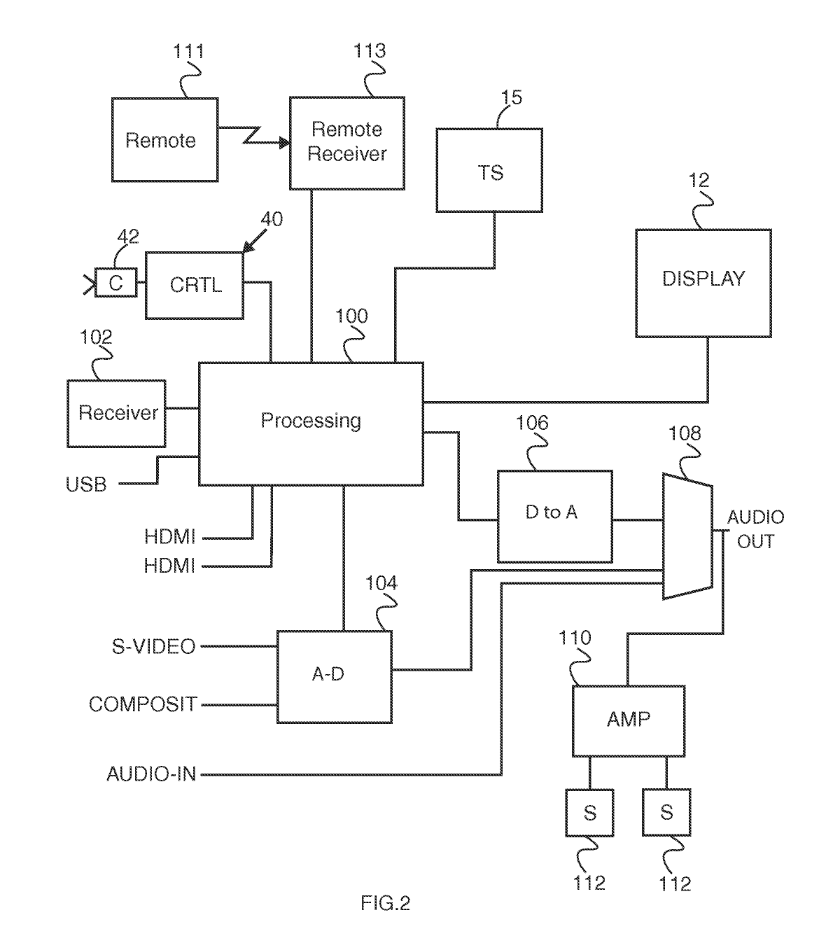

Referring to FIG. 2, a schematic view of a typical television 5 will be described. This figure is intended as a representative schematic of a typical television 5 and in practice, some elements are not present in some monitors/televisions 5 and/or additional elements are present in some monitors/televisions 5. In this example, a display panel 12 is connected to a processing element 100. The display panel 12 is representative of any known display panel including, but not limited to, LCD display panels, Plasma display panels, OLED display panels, LED display panels and cathode ray tubes (CRTs).

The processing element 100 accepts video inputs and audio inputs selectively from a variety of sources including an internal television broadcast receiver 102, High Definition Multimedia Interfaces (HDMI), USB ports and an analog-to-digital converter 104. The analog-to-digital converter 104 accepts analog inputs from legacy video sources such as S-Video and Composite video and converts the analog video signal into a digital video signal before passing it to the processing element. The processing element controls the display of the video on the display panel 12.

Audio emanates from either the broadcast receiver 102, the legacy source (e.g., S-Video) or a discrete analog audio input (Audio-IN). If the audio source is digital, the processing element 100 routes the audio to a digital-to-analog converter 106 and then to an input of a multiplexer 108. The multiplexer 108, under control of the processing element 100, selects one of the audio sources and routes the selected audio to the audio output and an internal audio amplifier 110. The internal audio amplifier 110 amplifies the audio and delivers it to internal speakers 112.

In this example, the processing element 100 accepts commands from a remote control 111 through remote receiver 113. Although IR is often used to communicate commands from the remote control 111 to the remote receiver 113, any known wireless technology is anticipated for connecting the remote control 111 to the processing element 100 including, but not limited to, radio frequencies (e.g., Bluetooth), sound (e.g., ultrasonic) and other spectrums of light. Furthermore, it is anticipated that the wireless technology be either one way from the remote 111 to the receiver 113 or two way.

The processing element is interfaced to a sensor 42 through a controller 40. Interfacing of the sensor 42 through a controller 40 is well known. In some embodiments, the sensor 42 is a camera and an image detected by the camera is used to determine the proximity of the viewer. In some embodiments, the sensor 42 is an ultrasonic ruler, emitting ultrasonic pulses and measuring the time until reflections are received back. Any known sensor 42 is anticipated, including sensors 42 that detect changes in capacitance, changes in Doppler waves, changes in light, etc. It is anticipated that the sensor 42 is housed in the bezel of the television 5 or, in some embodiments, housed in a base of the television 5, housed or integrated inside or behind the display 12, housed in a separate housing, etc.

The processing element 100 is also interfaced to a touch screen 15 as known in the industry. The processing element 100 receives, for example, touch coordinates indicating an X and Y position and perhaps a magnitude (Z-axis) of a touch. The processing element 100 then associates the touch coordinates with a user interface object/location currently displayed on the display 12 and processes the touch as if a mouse pointer was located at the same coordinates and a mouse button pressed.

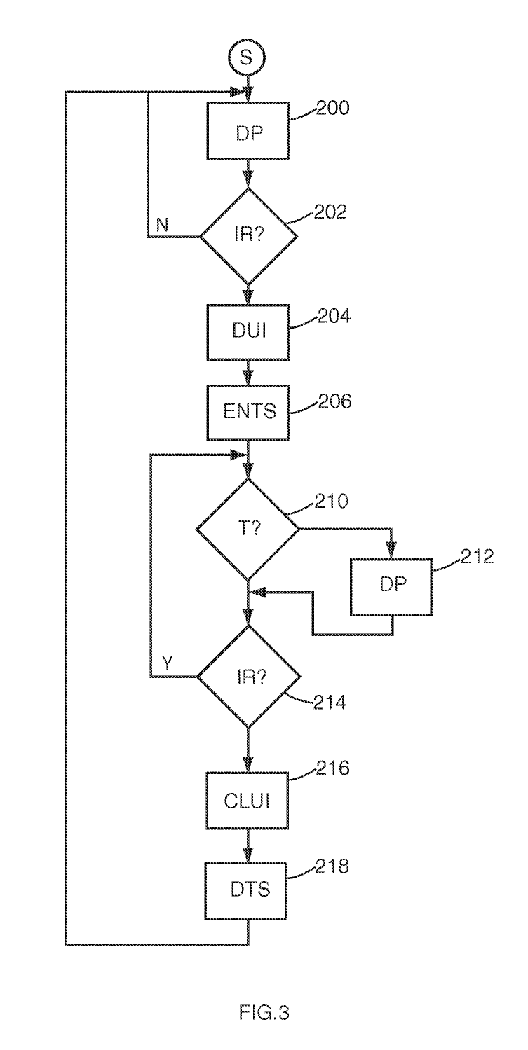

Referring to FIG. 3, a first flow chart will be described. This is an exemplary program flow executed within the processing element 100. Although it is anticipated that any information or content is displayed on the display 12, in this example, a television program is displayed 200. If a person or object is not detected 202 by the sensor 42 to be in range, the program continues to be displayed 200.

If a person or object is detected 202 by the sensor 42 it is determined if the person is within range or within a pre-determined distance. The pre-determined distance is a value that is set and stored in the device, preferably pre-set during manufacture or programming and, in some embodiments, the pre-determined distance is settable through a user interface as known in the industry.

If the person is in range, a touch user interface is displayed 204, either encompassing the entire display 12, a portion of the display 12, occluding the television program on the display, translucently overlaying the television program on the display, etc, as known in the industry. In one example, television controls are displayed in the user interface such as brightness control bars, volume control bars, etc. In another example, a keyboard is displayed in the user interface for entering data in, for example, a menu that was previously invoked by the remote control 111.

In some embodiments, after the user interface is displayed 204, the touch screen 15 is enabled 206 to accept touch commands. If a touch is detected 210, the touch is associated with a user interface element at the location of the touch and a related operation is performed 212. For example, if the touch is located over an up-arrow that is associated with a volume control, the operation performed 212 is to increase the volume and, if needed, update the user interface to correspond to the new volume setting.

Whether or not a touch is detected 210, the sensor 42 is consulted 214 to determine if the viewer is still in the proximity of the display 12. If the user is in the proximity 214, the previous steps to determine if a touch was made 210 and act on them 212 are repeated.

If the user is in no longer in the proximity 214 of the display 12, the user interface is closed 216, in some embodiments the touch screen 15 is disabled, and the flow repeats from the beginning.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for controlling a touch-screen of a device, the system comprising:
a display;
a processing element operatively coupled to the display;
a touch-screen coupled to the display, the touch-screen operatively coupled to the processor;
a sensing device operatively coupled to the processing element; and
software running on the processing element, the software reads the sensing device and determines a proximity of a viewer to the display and, if the proximity is within a pre-determined distance, the software enables the touch-screen and the software displays a touch-screen user interface on the display.

2. The system for controlling a touch-screen of a device of claim 1, wherein the touch-screen user interface includes user-interface features for setting parameters of the device.

3. The system for controlling a touch-screen of a device of claim 1, wherein the sensing device is an ultrasonic distance measuring device.

4. The system for controlling a touch-screen of a device of claim 1, wherein the sensing device is a camera.

5. The system for controlling a touch-screen of a device of claim 1, wherein the device is a television.

6. The system for controlling a touch-screen of a device of claim 1, wherein the device is a personal computer.

7. A system for controlling a touch-screen of a device, the system comprising:
a display;
a processing element operatively coupled to the display;
a distance sensor operatively coupled to the processing element; and
software running on the processing element, the software reads the distance sensor and the software determines if a viewer is within a pre-determined distance of the display and, if the viewer is within the pre-determined distance of the display, the software displays a touch-screen user interface on the display.

8. The system for controlling a touch-screen of a device of claim 7, wherein the software also enables the touch-screen operation after the software determines that the viewer is within the pre-determined distance of the display.

9. The system for controlling a touch-screen of a device of claim 7, wherein the touch-screen user interface includes user-interface features for setting parameters of the device.

10. The system for controlling a touch-screen of a device of claim 7, wherein the distance sensor is an ultrasonic distance measuring device.

11. The system for controlling a touch-screen of a device of claim 7, wherein the distance sensor is a camera.

12. The system for controlling a touch-screen of a device of claim 7, further comprising software running on the processing element that obtains a setting for the pre-determined distance from a viewer.

13. The system for controlling a touch-screen of a device of claim 7, wherein the pre-determined distance is three feet.

14. A method of controlling a user interface of a device, the method comprising:
providing a sensor, the sensor determines a distance between the device and a viewer;
detecting when the distance is less than a pre-determined distance;
if the distance is less than the pre-determined distance, displaying a touch-screen user interface on a display of the device.

15. The method of claim 14, further comprising the step of:
if the distance is greater than the pre-determined distance, removing the touch-screen user interface from the display.

16. The method of claim 14, further comprising the step of:
if the distance is less than the pre-determined distance, enabling a touch-screen interface, the touch screen interface interfaced with the display of the device.

17. The method of claim 14, further comprising the step of:
if the distance is greater than the pre-determined distance, disabling a touch-screen interface, the touch screen interface interfaced with the display of the device.

18. The method of claim 14, further comprising the step of:
presenting a user-interface and obtaining the pre-determined distance from the viewer of the device.

19. The method of claim 14, wherein the sensor is an ultrasonic distance measuring device.

20. The method of claim 14, wherein the device is a television.
